(19) United States
(12) Patent Application Publication
(10) Pub. No.: US 2009/0023480 A1
(43) Pub. Date: Jan. 22, 2009

(54) SYSTEM AND APPARATUS FOR DEVICE TO DEVICE CHARGING

(75) Inventors: AJOY NANDI, Pashan (IN); ASMA FARHIN, HAWTHORN WOODS, IL (US); FARHAN A. SIDDIQUE, LAKE VILLA, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/778,993

(22) Filed: Jul. 17, 2007

(51) Int. Cl. H04M 1/00

(52) U.S. Cl. 455/573

(57) ABSTRACT

A system comprises a first wireless communication device, a second wireless communication device. The first wireless communication device comprises a first male connector and a first female connector. The second wireless communication device comprises a second male connector and a second female connector. The first wireless communication device is capable of discharging power to the second wireless communication device when the first male connector extends outward from the first wireless communication device and removably connects to the second female connector.

### FIELD OF THE DISCLOSURE

The present disclosure relates generally to the field of power transfer from one device to another device and more particularly to system and apparatus for device and device charging.

### BACKGROUND

Personal electronic devices are widely used in today's information age. Mobile devices like cellular telephones, two-way radios, pagers, personal data assistants, portable computers and multimedia players are only some of the devices commonly used by people to stay organized and informed. Many individuals carry such devices wherever they go, outdoors as well as indoors. Rechargeable batteries are the workhorses that provide energy to these devices. Rechargeable batteries offer the user freedom of movement without having to sacrifice functionality of such devices.

Unfortunately, an unavoidable issue with a battery is running out of power. During such situations, a user of a mobile device is unable to operate the mobile device until the battery of the mobile device is recharged. This may result in a frustrating situation for the user and may cause undesirable circumstances. For instance, the user may not be able to pull out contact information stored in the mobile device which might be urgently required. Moreover, additional features like internet browsing, electronic capabilities, games, and other software applications are incorporated in the mobile devices which require comparatively a larger portion of the charge in the battery. As such, these applications may run down the battery of the mobile device, making the problem of a disabled mobile more prevalent.

Several approaches have been suggested to overcome the above mentioned problems that may include, charging the mobile device using phone to phone charging cables and travel chargers. These approaches may lead to additional cost of buying device to device charging cables and travel chargers. Also, while the user is traveling, carrying an extra cable or a travel charger to charge the mobile device might become a tiresome activity.

Accordingly, there is a need for an improved apparatus to provide device to device charging.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 depicts a system diagram of a communication system in which a wireless communication device may operate in accordance with some embodiments.

FIG. 2 depicts a view of an embodiment of a wireless communication device in accordance with some embodiments.

FIG. 3 depicts a view of an embodiment of a wireless communication device in accordance with some embodiments.

FIG. 4 depicts a block diagram of a wireless communication device in accordance with some embodiments.

FIG. 5 depicts a flow diagram of an operation of a wireless communication device in accordance with some embodiments.

FIG. 6 depicts a flow diagram of an operation of a wireless communication device in accordance with some embodiments.

FIG. 7 depicts a flow diagram of an operation of a wireless communication device in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

In accordance with the present invention, a wireless communication device comprises of a housing, a wireless transceiver, a battery, a male connector, a female connector, and a processor. The wireless transceiver and the processor are supported by the housing. The male connector and the female connector are connected to the housing of the wireless communication device. The male connector and the female connector are placed adjacent to one another, where the male connector discharges power and the female connector receives power.

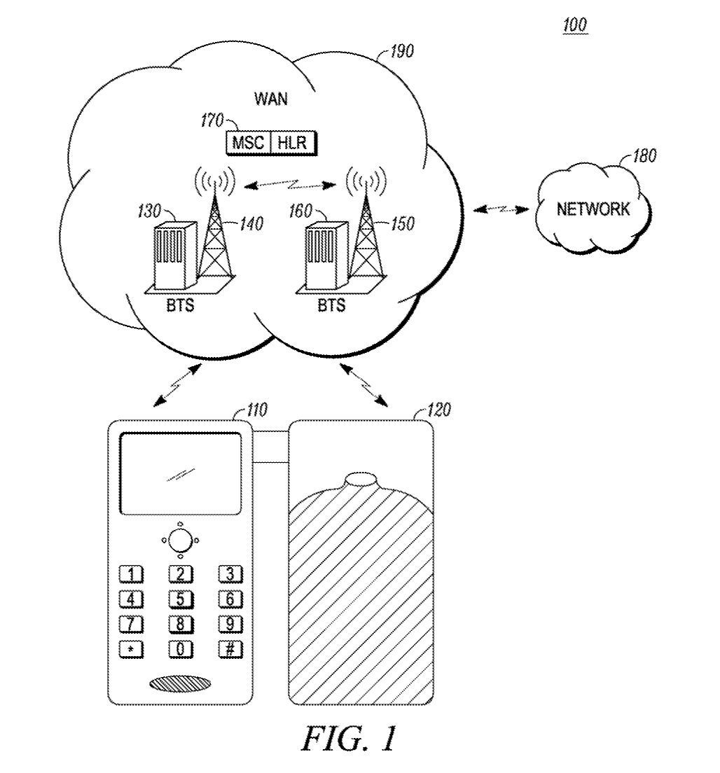

Turning now to the drawings where like numerals represent like components, FIG. 1 depicts a system diagram of a communication system 100 including wireless communication devices 110, 120. The communication system 100 also includes a cellular network 190 and a network 180.

The wireless communication devices 110, 120 are configured for charge transfer and charge reception. As used herein and described hereafter, charge transfer is a discharge of power to a wireless communication device and charge reception is a reception of power from the wireless communication device. In one example, as shown in FIG. 1, the wireless communication device 110 is kept face-up and the wireless communication device 120 is kept face-down. In this example, the wireless communication device 110 is transferring charge to the wireless communication device 120. It is understood that the wireless communication device 120 may also transfer charge to the wireless communication device 110. The wireless communication devices 110, 120 may be connected with one another via a Universal Serial Bus (USB) connection, a mini USB connection, or any other connection standard.

The wireless communication devices 110, 120 may communicate with the cellular network 190 using wireless communication protocols such as Advanced Mobile Phone System (AMPS), Code Division Multiple Access (CDMA), Time Division Multiple Access (TDMA), Global System For Mobile Communications (GSM), Integrated Digital Enhanced Network (iDEN), General Packet Radio Service (GPRS), Enhanced Data for GSM Evolution (EDGE), Universal Mobile Telecommunications System (UMTS), Wideband Code Division Multiple Access (WCDMA), and their variants. The wireless communication devices 110, 120 may communicate using an ad-hoc network such 802.11a and the like. The wireless communication devices 110, 120 may also communicate using short-range wireless communication like Bluetooth™, infrared, and the like.

The cellular network 190 is a wide area network (WAN) and comprises various components such as Base Transceiver Stations (BTS) 130, 160 and Mobile Switching Center (MSC) 170 which also comprises a Home Location Register (HLR). It is to be understood that the WAN 190 as shown in FIG. 1 is for illustrative purposes only, and that the WAN will comprise a number of BTSs, MSCs, HLRs, as well as other components not mentioned herein. The WAN 190 may also communicate with other networks such as network 180, which may be the Internet, which may make use of any suitable means including, but not limited to a leased telephone line, T1, E1, infrared, or a radio frequency point-to-point connection.

The cellular network 190 also comprises wireless towers 140, 150 which establish a communication link with the wireless communication devices 110, 120. Wireless towers 140, 150 may also transfer voice and data signals via the communications link. The communication link is a wired communication link, a wireless communication link, and/or a combination of both. In one example, the wireless communication link is a high-speed data communication link. In one example, the wireless towers 140, 150 are base stations which transfer data through GPRS or the Internet to the wireless communication devices 110, 120.

In one example, the wireless communication device 110 may be known as a first wireless communication device. The wireless communication device 120 may be known as a second wireless communication device. In another example, the wireless communication device 110 may also be known as a charged wireless communication device and the wireless communication device 120 may be known as a discharged wireless communication device.

In one example, the wireless communication devices 110, 120 may also be known as client devices, mobile subscribers, mobile stations, mobile devices, and the like. The wireless communication devices 110, 120 may be any suitable wireless communication devices, including cell phones, personal digital assistants (PDAs), hand-held computers, Bluetooth headsets, and the like. Further, it should be understood that the present invention is not limited to a wireless communication device. Other types of wireless access terminals which include fixed wireless terminals may be used. For a better understanding, only the term wireless communication device is used herein and discussed hereafter. However, it should be understood that the term “wireless communication device” in the claims and description below includes both truly wireless communication devices (e.g., mobile phones, wireless handheld computers), stationary wireless terminals (e.g., fixed wireless router) or any other electronic battery operated devices coupled to a network.

Operationally in the illustrated embodiment of the communication system 100, the wireless communication device 110 discharges power to the wireless communication device 120. The wireless communication device 110 may check for the availability of power before discharging power to the wireless communication device 120. The wireless communication device 120 may indicate amount of power required from the wireless communication device 110. The wireless communication device 110 may then discharge power until level of power reaches a threshold limit.

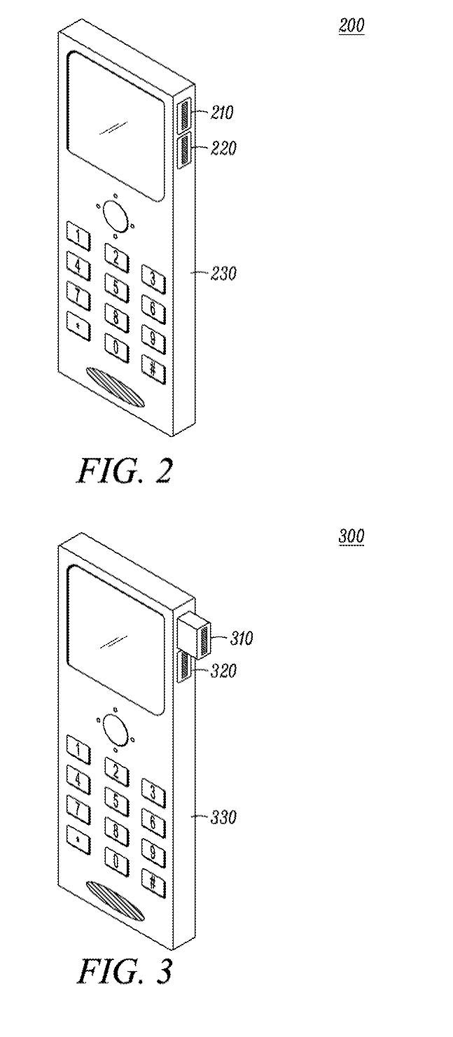

Referring to FIG. 2, there is provided a view 200 of an embodiment of a wireless communication device 110 in accordance with some embodiments. For a better understanding of the present invention, only the wireless communication device 110 is explained. However, it is to be understood that the wireless communication device 120 may also have the same explanation. The wireless communication device 110 includes a housing 230, a male connector 210 and a female connector 220. In one example, the male connector 210 may be a retractable connector and is configured to discharge power to another wireless communication device, such as the wireless communication device 120. The female connector 220 may be configured to receive power from another wireless communication device. In one example, the male connector 210 may be known as a first connector and the female connector 220 may be known as a second connector.

In one example, the male connector 210 and the female connector 220 are placed adjacent to one another. In this example, the male connector 210 and the female connector 220 are placed on a single side of the wireless communication device 110. It is to be understood that the male connector 210 and the female connector 220 are placed on a right side only for illustrative purposes and may be placed on any side of the wireless communication device 110 depending upon manufacturer's design. In another example, the male connector 210 and the female connector 220 may be located at opposite sides of the wireless communication device 110. Operationally, when charge transfer is initiated the male connector 210 is activated and protrudes out from its home position, as shown in FIG. 3 as 310.

Referring to FIG. 3, there is provided a view 300 of an embodiment of a wireless communication device 110 in accordance with some embodiments. The wireless communication device 110 includes a housing 330, a protruded male connector 310, and a female connector 320. In one example, the male connector 310 is less than the thickness of the wireless communication device 110 in size. This aspect of the male connector 310 does not disturb the form factor of the wireless communication device 110.

Returning back to FIG. 1, as mentioned above the wireless communication device 110 is known as the first wireless communication device 110 and the wireless communication device 120 is known as the second wireless communication device 120. In one example, the first wireless communication device 110 comprises a first male connector and a first female connector. Similarly, the second wireless communication device 120 comprises a second male connector and a second female connector. As mentioned above, the male connector 210 and the female connector 220 are adjacent to one another. Similarly the first male connector and the first female connector are adjacent to one another, and the second male connector and the second female connector are adjacent to one another.

Operationally in the illustrated embodiment, the first wireless communication device 110 discharges power to the second wireless communication device 120 when the first male connector extending outwards from the first wireless communication device 110 removably connects to the second female connector. Alternatively, the first wireless communication device 110 receives power from the second wireless communication device 120 when the second male connector extending outwards from the second wireless communication device 120 removably connects to the first female connector.

In one example, the first male connector and the second female connector may operate on common standards. For example, both the first male connector and the second female connector may be of a USB type-A connector, a USB type-B connector, a USB type-AB connector, or other connector standards. It is to be understood that the first male connector and the second female connector may also operate on a combination of the above mentioned connector standards. Similarly, the second male connector and the first female connector may operate on common standards or a combination of the above mentioned connector standards. In another example, the first male connector, the first female connector, the second male connector, and the second female connector, may operate on one common standard.

In one example, the first wireless communication device 110 and the second wireless communication device 120 may exchange data with one another. For example, the first male connector may transfer data to the second female connector. Similarly, the second male connector may transfer data to the first female connector.

In one example, the first male connector may transfer charge and exchange data with the second female connector simultaneously. Similarly, the second male connector may transfer charge and exchange data with the first female connector simultaneously.

In another example, the first male connector and the first female connector of the first wireless communication device 110 may be connected to the second male connector and the second female connector the second wireless communication device 120 at the same instance. For example, the first male connector may be connected to the second female connector and the second male connector may be connected to the first female connector at the same instance, such that transfer of charge and data may occur simultaneously. In this case, as an example, the first male connector may discharge power to the second female connector and the second male connector may transfer data to the first female connector or vice-versa.

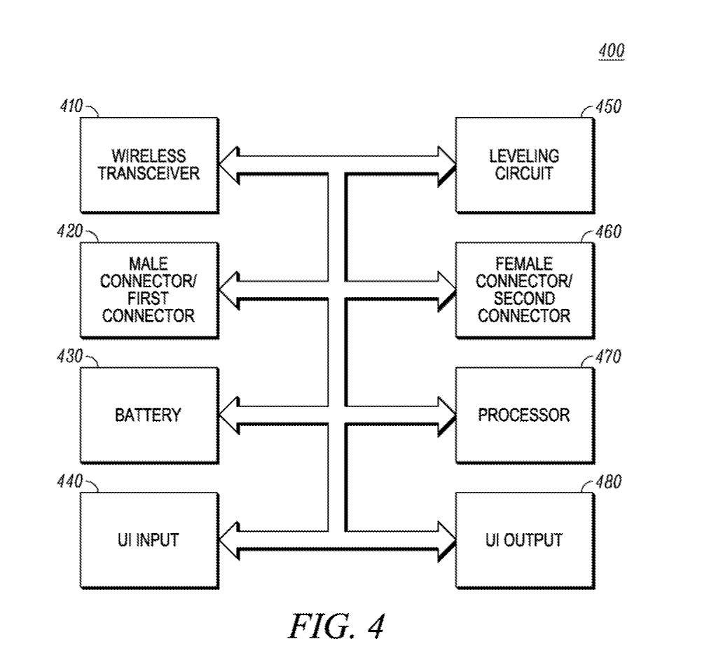

Referring now to FIG. 4, there is provided a block diagram of internal components 400 of the wireless communication device 110. The internal components 400 may be supported by a housing of the wireless communication device 110. For a better understanding of the present invention, internal components 400 of only the wireless communication device 110 are described hereafter. However, it should be understood that the internal components 400 may be for the wireless communication device 120 as well. The wireless communication device 110 includes a wireless transceiver 410, a leveling circuit 450, a male connector 420, a female connector 460, a battery 430, a processor 470, one or more input devices 440, and one or more output devices 480.

The wireless transceiver 410 transmits voice signals and data signals (e.g. SMS, GPRS). In one example, the wireless transceiver 410 communicates using the wireless communication protocols mentioned earlier. As is known, the wireless transceiver 410 is a combination of a wireless transmitter and a wireless receiver. Therefore, the wireless transmitter and the wireless receiver may be used separately instead of the wireless transceiver 410. The wireless transceiver 410 may also be configured to wirelessly connect with a remote device, such as the wireless towers 140, 150.

The battery 430 supplies power to rest of the internal components 400. In one example, the battery 430 may be configured to discharge power to another wireless communication device, such as the wireless communication device 120. In another example, the male connector 420 may be configured to discharge power from the battery 430 of the wireless communication device 110 to the wireless communication device 120. The battery 430 may also be configured to store power. In one example, the female connector 460 may be configured to receive power from another wireless communication device and direct the received power to the battery 430.

The male connector 420, as mentioned above, may be configured to discharge power to another wireless communication device. In one example, the male connector 420 may also be configured to discharge power to various other electronic devices, such as an MP3 player, a digital camera, and the like. In another example, the male connector 420 may also be configured to transmit data from the wireless communication device 110 to other communication devices. The male connector 420 may be a retractable connector. For example, the male connector 420 may protude out of the wireless communication device 110 when activated. In this example, the male connector 420 may retract back to home position when deactivated. The male connector may be a USB connector, a mini-USB connector, or any other connector for discharging power and transferring data. Examples of a USB connector are, but not limited to type-A, type-B, type-AB, USB 2.0, Inter-chip USB 1.0, and the like. In one example, the male connector 420 may be configured to transmit data and discharge power simultaneously.

The female connector 460 may be configured to accept power from another wireless communication device. In one example, the female connector 460 may also be configured to accept power from various other electronic devices, such as an electric charger, a travel charger, and the like. In another example, the female connector 460 may also be configured to receive data from other communication devices, such as wireless communication device 120. The female connector 460 may be a USB connector, a mini USB connector or any other connector configured for receiving power and data. In one example, the female connector 460 may be configured to receive data and power simultaneously.

In one example, the male connector 420 and the female connector 460 may be combined together to form a multipurpose connector. The multipurpose connector may be configured to discharge power and receive power. In this case, the multipurpose connector may protrude out while discharging power and retract back while receiving power. The multipurpose connector may also be configured to transfer and receive data.

In another example, the male connector 420 and the female connector 460 may be located opposite to one another on a rotating axis. In one example, when the male connector and the female connector are vertical opposite to one another, they hide inside the wireless communication device 110. In this case, at 90° rotation (clockwise or anti-clockwise), at least one of the male connector 420 and the female connector 460 may protrude out of the wireless communication device 110 while the other connector remains inside the wireless communication device 110. Again after 90° rotation (clockwise or anti-clockwise), both the male connector and the female connector will move inside the wireless communication device 110.

The leveling circuit 450 may be configured to indicate a level of charge in the battery 430. In one example, the leveling circuit 450 may also be configured to indicate a threshold limit of charge. As used herein and described hereafter, the threshold limit of charge is a limit of charge to be transferred to another wireless communication device. In another example, the threshold limit of charge may also be the limit of charge to be accepted from another wireless communication device. In one example, the leveling circuit 450 may be configured to indicate amount of power to be discharged from the male connector 420. The leveling circuit 450 may also be configured to indicate amount of power to be accepted from the female connector 460. In another example, the leveling circuit 450 may be connected to an output (e.g. display screen) of the wireless communication device 110 and may display the level of charge. This level of charge may indicate a user of the wireless communication device 110 about the amount of power that can be discharged from the male connector 420 and the amount of power that can be accepted from the female connector.

The processor 470 may be configured to operate and instruct internal components 400 of the wireless communication device 110. In one example, the processor 470 is operationally coupled to the male connector 420 and the female connector 460. In another example, the processor 470 may be programmed with software application to accept power from another wireless communication device and discharge power to another wireless communication device. For example, when the user of the wireless communication device 110 activates the charge transfer, the processor 470 in turn activates the male connector 420 for discharging power to another wireless communication device. In another example, the processor 470 may also activate the female connector 460 for charge reception from another wireless communication device.

The input and output devices 440, 480 provide interface for the user of the wireless communication device 110 to facilitate the proximity payment application. The input and output devices 440, 480 of the internal components 400 include a variety of video, audio and/or mechanical outputs. For example, the output device(s) 480 includes a video output device such as a liquid crystal display and light emitting diode indicator, an audio output device such as a speaker, alarm and/or buzzer, and/or a mechanical output device such as a vibrating mechanism. Likewise, by example, the input device(s) 440 includes a video input device such as an optical sensor (for example, a camera), an audio input device such as a microphone, and a mechanical input device such as a flip sensor, a keyboard, a keypad, a selection button, a touch pad, a touch screen, a capacitive sensor, a motion sensor, and a switch. Actions that actuate one or more input devices 440 include, but are not limited to, opening the wireless communication device, unlocking the device, moving the device to actuate a motion, moving the device to actuate a location positioning system, and operating the device.

It is to be understood that FIG. 4 is for illustrative purposes only and is for illustrating internal components 400 of the wireless communication device 110, in accordance with the present invention, and is not intended to be a complete schematic diagram of the various components required for the wireless communication device 110. Therefore, the wireless communication device 110 may include various other components not shown in FIG. 4 and is still within the scope of the present invention.

Operationally during charge transfer, the wireless communication device 110 activates the male connector 420 to discharge power to another wireless communication device, such as the wireless communication device 120. In one example, the user of the wireless communication device 110 activates the charge transfer using a user interface, such as the input device 440. The leveling circuit 450 then displays the level of charge available in the battery 430. In one example, the leveling circuit 450 also displays the threshold limit of charge for charge transfer. The male connector 420 is activated if the level of charge is above the threshold limit. The wireless communication device 110 is then transferred to another wireless communication device, such as wireless communication device 120.

Operationally during charge reception, the wireless communication device 110 detects a connection when the female connector 460 of the wireless communication device 110 comes in contact with a male connector of another wireless communication device. The leveling circuit 450 displays the level of charge available in the battery 430. In one example, the leveling circuit 450 also displays the level of charge required by the wireless communication device 110. The female connector 460 accepts power from another wireless communication device and directs the accepted power to the battery 430 until the threshold limit of charge is achieved.

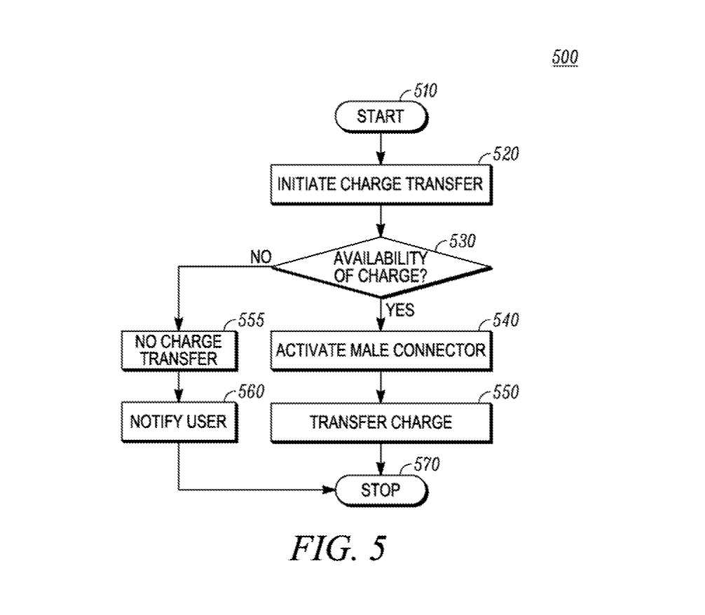

Referring to FIG. 5, shown is a flow diagram 500 of an operation of a wireless communication device, e.g. wireless communication device 110 or 120, during charge transfer. The charge transfer is initiated (step 520) by the wireless communication device. In one example, a user of the wireless communication device initiates the charge transfer using a user interface, such as an input device 440. After the charge transfer is initiated, availability of charge is checked (step 530). In this case, a leveling circuit, e.g. leveling circuit 450 may check whether the level of charge available in a battery of the wireless communication device is above the threshold limit or not. If the level of charge is above the threshold limit, a male connector, e.g. the male connector 420, is activated (step 540). After the male connector is activated, the charge is transferred (step 550). Alternatively, if there is no charge available, no charge transfer takes place (step 555) and the user of the wireless communication device is notified (step 560).

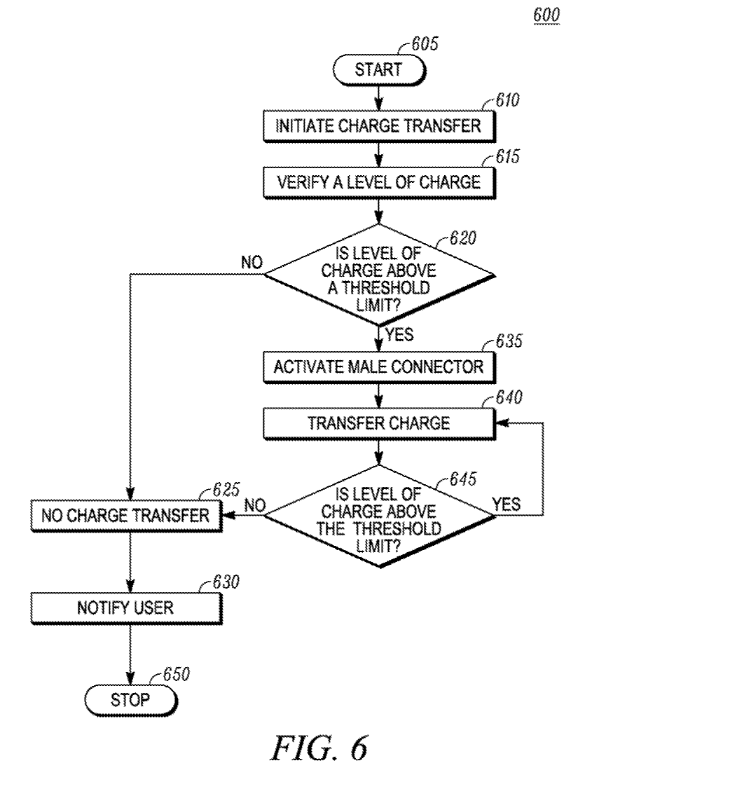

Referring now to FIG. 6, shown is a more detailed flow diagram 600 of an operation of a wireless communication device e.g. wireless communication device 110 or 120, during charge transfer. The charge transfer is initiated (step 610) by the wireless communication device. As mentioned above, the user of the wireless communication device initiates the charge transfer using the user interface. After charge transfer is initiated, the level of charge is verified (step 615), e.g. by leveling circuit 615, and it is checked whether the level if charge is above the threshold limit or not (step 620). If the level of charge is below the threshold limit, no charge transfer takes place (step 625) and the user of the wireless communication device is notified (step 630). In one example, the user may be notified using an output device, such as output device 480. In this example, the notification may be a buzzer sound, an alarm sound, a text message, a glowing Light Emitting Diode (LED), and the like. For example, the notification to the user may be a text message stating, “Charge transfer stopped—Not enough charge available”.

Alternatively, if the level of charge is above the threshold limit, a male connector is activated (step 635). After the male connector is activated, the charge is transferred (step 640) from the wireless communication device. In one example, the male connector, e.g. male connector 420, of the wireless communication device may protrude out from its home position (as shown in FIG. 3) and connect with a female connector, e.g. the female connector 460, of another wireless communication device. For example, as shown in FIG. 1, a male connector of the wireless communication device 110 may connect to a female connector of wireless communication device 120.

During charge transfer, the leveling circuit continuously checks whether the level of charge is above the threshold limit or not (step 645). If the level of charge is above the threshold limit, the charge transfer continues (step 640). Otherwise, if the level of charge reaches the threshold limit, the transfer of charge is stopped (step 625) and the user is notified (step 630).

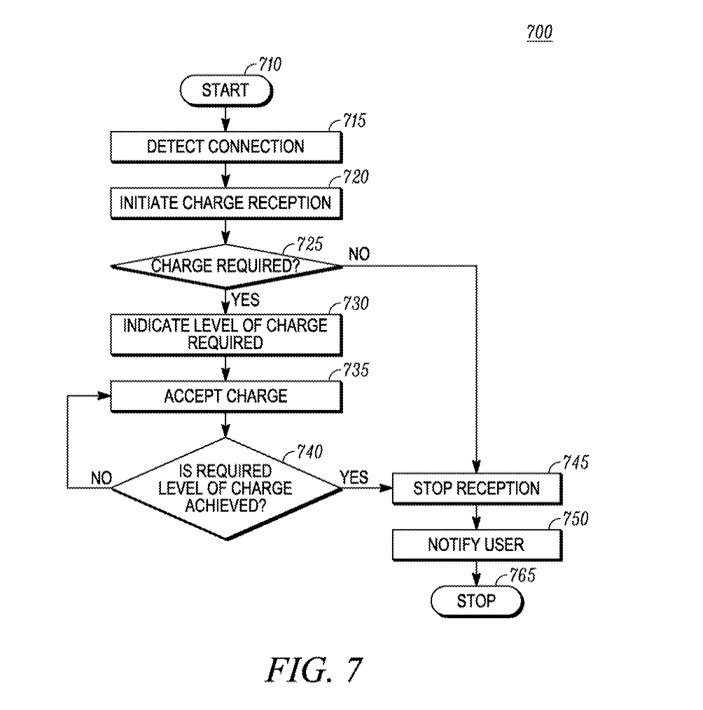

Referring to FIG. 7, shown is a flow diagram 700 of an operation of a wireless communication device during charge reception. A connection is detected (step 715) by the wireless communication device. In one example, a female connector of the wireless communication device detects a male connector of another wireless communication device. When the male connector is detected charge reception is initiated (step 720) and it is checked whether the charge is required or not (step 725). In one example, the leveling circuit checks whether the charge is required or not. If the charge is not required, the charge reception is stopped (step 745) and the user of the wireless communication device is notified (step 750).

Alternatively, if the charge is required, the user of the wireless communication device is indicated with the level of charge required (step 730) for the wireless communication device to attain the threshold limit. In one example, the leveling circuit checks the level of charge required to attain the threshold limit. In one example, the required level of charge may be decided by the user of the wireless communication device. For example, the user may need to pull out any contact information from the wireless communication device, or may need to make an urgent call. In this case, the user may key in the required amount of charge depending upon the level of charge available using an input interface of the wireless communication device, e.g. the input device 440.

The charge is accepted (step 735) depending upon the requirement and it is continuously checked whether the required level of charge is achieved or not (step 740). If the required level of charge is achieved, the reception of charge stops (step 745) and the user is notified (step 750). In one example, the wireless communication device may include a notification circuit to notify the user of the wireless communication device. In another example, the threshold limit of charge may be decided by the user depending upon the usage of the user. Alternatively, the threshold limit may be configured by a manufacturer of the wireless communication device. In one example, the threshold limit may also be configured by the manufacturer of the battery.

In this document, relational terms such as first and second, top and bottom, and the like may be used solely to distinguish one entity or action from another entity or action without necessarily requiring or implying any actual such relationship or order between such entities or actions. The above description and the diagrams do not illustrate do not necessarily require the order illustrated.

The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A system, comprising:
a first wireless communication device having a first male connector and a first female connector; and
a second wireless communication device having a second female connector,
wherein, the first wireless communication device is capable of discharging power to the second wireless communication device when the first male connector extends outward from the first wireless communication device and removably connects to the second female connector.

2. The system of claim 1, wherein the first wireless communication device is capable of accepting power from the second wireless communication device when a second male connector extends outward from the second wireless communication device and removably connects to the first female connector.

3. The system of claim 1, wherein the first male connector and the second female connector operate on a common standard.

4. The system of claim 1, wherein the first wireless communication device exchanges data with the second wireless communication device.

5. The system of claim 4, wherein the first male connector transmits data to the second female connector.

6. The system of claim 4, further comprising a second male connector of the second wireless communication device that transmits data to the first female connector.

7. The system of claim 1, wherein the first male connector is a USB connector for discharging power.

8. The system of claim 1, further comprising a second male connector of the second wireless communication device that is a USB connector for discharging power.

9. The system of claim 1, wherein the first female connector is a USB connector for receiving power.

10. The system of claim 1, wherein the second female connector is a USB connector for receiving power.

11. The system of claim 1, wherein the first male connector and the first female connector are adjacent to one another.

12. The system of claim 1, further comprising a second male connector of the second wireless communication device, wherein the second male connector and the second female connector are adjacent to one another.

13. A wireless communication device, comprising:
a housing;
a wireless transceiver supported by the housing and configured to communicate wirelessly with at least one remote device;
a battery supported by the housing and configured to discharge and store power;
a male connector and a female connector exposed at the housing and located substantially adjacent to one another; and
a processor supported by the housing and operationally coupled to the male connector and the female connector.

14. The wireless communication device of claim 13, wherein the male connector is a retractable connector.

15. The wireless communication device of claim 13, wherein the male connector is a USB connector for discharging power.

16. The wireless communication device of claim 13, wherein the female connector is a USB connector for receiving power.

17. The wireless communication device of claim 13, wherein the male connector transmits data and the female connector receives data.

18. A communication device, comprising:
a housing;
a wireless transceiver supported by the housing and configured to communicate with at least one remote device;
a battery supported by the housing and configured to discharge and store power;
first and second connectors exposed at the housing, the first connector configured to discharge power from the battery and the second connector configured to direct power to the battery; and
a leveling circuit supported by the housing and configured to indicate at least one threshold level of charge.

19. The communication device of claim 18, wherein the leveling circuit indicates:
(a) amount of power to be discharged from the first connector; and
(b) amount of power to be accepted from the second connector.

20. The communication device of claim 18, wherein the first connector and the second connector are USB connectors.
